(19) United States
(12) Patent Application Publication
(10) Pub. No.: US 2008/0286535 A1
(43) Pub. Date: Nov. 20, 2008

(54) METHOD FOR THE PRODUCTION OF THERMOADHESIVE LABELS WITH LASER TECHNOLOGY AND LABELS THUS OBTAINED

(76) Inventor: Emanuele Acatti, Milano (IT)

Correspondence Address: KNOBBE MARTENS OLSON & BEAR LLP, 2040 MAIN STREET, FOURTEENTH FLOOR, IRVINE, CA, 92614, US

(21) Appl. No.: 12/121,669

(22) Filed: May 15, 2008

Related U.S. Application Data
(60) Provisional application No. 60/939,004, filed on May 18, 2007.

(51) Int. Cl. B44C 1/17; B32B 37/00

(52) U.S. Cl. 428/195.1; 156/277

(57) ABSTRACT

A thermoadhesive label production method is described which contemplates the following steps: printing the transfer (3), according to any process of the known art, restricted only to the boxes and to the shape within which each label will be confined in general; laser etching the trademarks and writings characterising the label onto the transfer (3); blanking or cutting.

### CROSS-REFERENCE TO RELATED APPLICATIONS

This application claims the benefit and priority to U.S. Provisional Application Ser. No. 60/939,004, filed on May 18, 2007. The disclosure of the above-referenced application is hereby expressly incorporated by reference in its entirety.

### BACKGROUND OF THE INVENTION

1. Field of the Invention

The present invention relates to a method for the production of thermoadhesive labels for clothing garments by means of laser technology and corresponding labels.

2. Description of the Related Art

Each clothing garment, in accordance with the laws in force, must carry an informative label, on which some information, including the company trademark, the yarn composition, the size, etc., may be read.

There are various types of labels, e.g. fabric or printed labels, applied onto the garment by sewing or thermal adhesion or gluing. Specifically, the use of thermoadhesive transfers is becoming ever increasingly widespread. According to this technique, the transfer product layer, e.g. polyurethane, when heated by means of hot presses is released from its supporting sheet, formed by either polyester paper or any releasing support, to be fixed onto the fabric of the clothing garment.

The printing methods currently in use are of the silkscreen, offset, silkscreen/offset type.

Such methods imply that the product is printed in sheets or reels, and specifically the printing in sheets involves the subsequent cutting of the single labels from the sheet.

As it is not advantageous to print a few sheets or reels in relation to the contingent needs due to the fixed printing equipment setup costs, it is understood that such a label production method inflicts costs related to the storage of considerable amounts of product for each type of garment and for each size.

Another problem which causes a considerable waste of resources relates to the quality control of the labels themselves, as the quality of the printing processes provided by the known art is extremely sensitive to environmental conditions, such as dust, ink drying, etc., especially if the extremely small size of the typeface are taken into account.

Specifically, if the product is printed in reels, when a quality fault is found on a portion of the reel, the reel itself must be removed, deprived of such a portion, jointed and repositioned. Instead, if the transfer is made in sheets, there occurs the additional problem of cutting and ensuring the homogeneousness of the dimensions of the labels and, furthermore, the gluing operation must be performed by hand.

### SUMMARY OF THE INVENTION

It is therefore the object of the present invention to overcome all of the aforesaid drawbacks and to indicate a method for the production of labels of the thermoadhesive transfer type, e.g. for application on fabrics or materials in general and corresponding labels thus obtained, so as to be able to print even very small amounts of labels and wordings with the maximum respect of quality standards, without thus needing to resort to the previously illustrated costly procedures.

It is the object of the present invention to provide a method for the production of labels on thermoadhesive transfers, e.g. adapted to be applied onto fabric or other material in general, so that the most part of the printing of writings, trademarks and wordings on said transfers is obtained by means of laser technology.

It is the specific object of the present invention to provide a method for the production of labels of the thermoadhesive transfer type, e.g. for application on fabric or material in general, and corresponding labels thus obtained, as described in greater detail in the claims which form an integral part of the present description.

### BRIEF DESCRIPTION OF THE DRAWINGS

Further objects and advantages of the present invention will be apparent from the following detailed description of an embodiment of the same and from the accompanying drawings exclusively provided by way of non-limitative example, in which: FIG. 1) Example of transfer material after the step of printing the boxes or the label delimiting shapes in general.

FIG. 2) Section view of a label applied onto fabric (1) highlighting the occurred removal of the upper layer (2) of transfer material (3) by means of laser for the etching of trademarks, writings and wordings.

FIG. 3) Section view of a label applied onto fabric (1) highlighting the occurred removal of the upper layer (2) of transfer material (3) related to the background of the label.

The same reference numbers in the figures identify the same elements.

### DETAILED DESCRIPTION OF THE PREFERRED EMBODIMENT

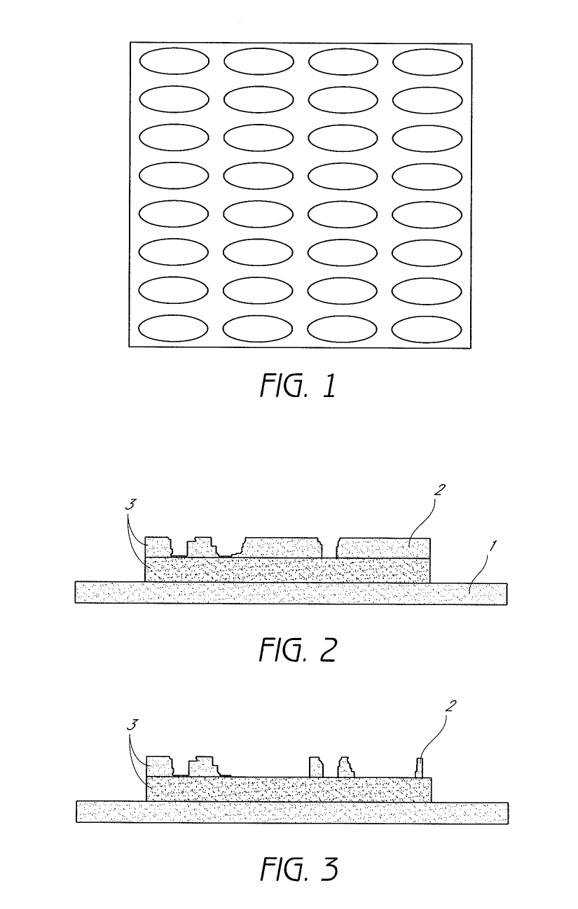

The method object of the present invention consists of the following steps:
a. printing the transfer (3), according to any process of the known art, e.g. by means of silkscreen or offset printing, restricted only to the boxes and to the shape within which each label will be confined in general, FIG. 1;
b. laser etching trademarks and writings characterising the label on transfer (3), FIGS. 2 and 3.

It is important to underline that, in the specific case of products in sheets, the laser etching on transfer (3) may be performed directly on the single label rather than by sheets, as the step of cutting the sheets themselves may precede that of etching. Although being possible, it would not be convenient to proceed with the cutting before the etching in the case of products in reels.

As the modern laser etching device control systems make the switching from one image to another immediate, besides making the prototyping process immediate and cost-effective, and as the intrinsic accuracy of the type of machining ensures high quality standards to the extent of cutting control costs to zero, it becomes possible to integrate the following steps:
1. printing
2. etching (or cutting)
3. cutting (or etching)
4. gluing
   in a single automated process, with the complete elimination of the storage of labels, in addition to the further, inevitable, saving of human and economic resources deriving from automatic machining.

The cutting process may thus be performed by means of cutters or by means of the laser etching device itself, furthermore, the etching process for removing layer (2) may involve both the typeface or trademarks and the background, i.e. the machining may be either positive or negative, refer to FIG. 2 and FIG. 3.

It is thus apparent that, by restricting the step of printing only to the shapes of the labels and remitting the making of trademarks and writings to the laser photoetching process, the storage and quality control costs are cut to zero; furthermore, the flexibility of the photoetching process allows the complete integration of the four steps listed above in a single production process, which also cuts the costs related to the manual application of the labels to zero.

Programming the laser machine appropriately so as to obtain the required writings represents standard technique. Furthermore, the switching from one programming to others may be managed by a common super controller which supervise the entire label application process and thus, also the etching of the same which may be subordinated, for example, to the size or type of garment (1) which may be varied in real time during the production process.

Other variants of the described non-limitative example are possible, without departing from the scope of protection of the present invention, comprising all equivalent implementations for a person skilled in the art.

From the description above, a person skilled in the art will be capable of implementing the object of the invention without introducing further details.

What is claimed is:

1. A thermoadhesive label production method comprising the following steps:
printing the transfer (3), according to any process of the known art, restricted only to the boxes and to the shape within which each label will be confined in general;
laser etching trademarks and writings characterising the label on the transfer (3);
blanking or cutting.

2. A method according to claim 1, wherein the steps of producing, further comprise that of gluing onto the clothing garment.

3. A method according to claim 1, wherein the laser technology printing may be either by contribution or ablation of material.

4. A method according to claim 1, wherein said step of cutting or blanking the transfer product is made either before or after the step of etching.

5. A method according to claim 1, wherein the step of cutting is performed by means of cutters or by means of the laser device itself.

6. Thermoadhesive transfer labels obtained by means of a method according to claim 1.
